(19) United States
(12) Patent Application Publication
(10) Pub. No.: US 2005/0220080 A1
(43) Pub. Date: Oct. 6, 2005

(54) System, method, computer program product, and business method for device group management using virtual device domain

(75) Inventors: Sami Ronkainen, Oulu (FI); Seppo Puolitaival, Oulunsalo (FI); Philip Ginzboorg, Espoo (FI); Miika Silfverberg, Vantaa (FI); Amrik Dhillon, Surrey (CA); Maini Williams, Tampere (FI); Olli Silven, Oulu (FI)

Correspondence Address: FOLEY & LARDNER, 321 NORTH CLARK STREET, SUITE 2800, CHICAGO, IL, 60610-4764, US

(73) Assignee: Nokia Corporation, NOKIA GROUP (FI)

(21) Appl. No.: 10/816,694

(22) Filed: Apr. 1, 2004

(51) Int. Cl. H04L 12/66

(52) U.S. Cl. 370/352

(57) ABSTRACT

A method, system, computer program product, and business method manage physical devices using a virtual device domain. The method includes establishing a virtual device for each physical device of one or more devices associated with a user and synchronizing the virtual device with one or more other virtual devices.

### FIELD OF THE INVENTION

The present invention relates to techniques for synchronizing and managing data between various devices.

### BACKGROUND OF THE INVENTION

The number of communications enabled devices is growing rapidly. Many individuals use more than one personal communications device. For example, many people own a laptop, personal digital assistant (PDA) and one or more mobile phones. There is a need to have the same essential data available regardless of the device the individual carries along. For instance, it is desirable to have one's music collection available for playback using various devices. Furthermore, the same person may need to control remotely a home security system and receive its alarms, again regardless of the device carried along.

Another important user need is protection of personal data against loss of device. The memory capacities of portable devices are growing rapidly. Not all of the users are able to carry out or even be aware of backup and synchronization procedures, or have access to a personal computer (PC), which is usually needed.

Infostick is a physical memory device with a large capacity that can be taken from one device to another, provided that the necessary hardware interfaces exist. See, N. Khotake, J. Rekimoto and Y. Anzai, “InfoStick: an interaction device for Inter-Appliance Computing”, Workshop on Handheld and Ubiquitous Computing (HUC'99), 1999. Similar solutions can be built on CompactFlash® (see http://www.compactflash.org), MultiMediaCard™ (see http://www.mmca.org), or SmartMedia™ card (see http://www.ssfdc.or.jp/). Removable memory is a rather elegant solution to information availability. But an accessory that is inserted/removed is prone to loss. Thus, backups are still needed for loss protection. Furthermore, if the user has several physical memory devices, their synchronization becomes a problem.

Typically, personal information accumulates over a long period of time, so synchronizing the devices is a rapid procedure, if carried out frequently. However, user action is needed, as well as proximity of the devices for conventional synchronization operations. With multiple devices, synchronizing soon becomes complicated and is easily left undone. The trigger for synchronization often occurs only when the user is swapping devices, requiring lots of data to be synchronized, which leads to an unacceptable duration of the procedure.

Many devices, such as PDAs and mobile communicators, contain personal information that needs to be available when needed and protected from loss. However, the more devices a person owns, the more difficult it becomes to properly synchronize and backup the information. Typically, synchronizations and backups are done locally against PCs or between similar devices, e.g. using the SyncML protocol, or with the transfer of a physical memory device. A small amount of information can also be carried over in a GSM SIM card. Some conventional systems exist, in which synchronization of data such as phonebook contents or calendar entries is done against a network service. However, such conventional systems only supports personal information management (PIM) applications.

In reality, handheld devices contain important data related to device, service configuration, and personalization information that should also be protected from loss. Furthermore, it would be desirable to offer a possibility to backup any data generated or purchased by the user, some of which should also be synchronized between devices.

An example of data that is needed to be available in any other devices the user owns is personal information data like calendar data, or a list of contacts. Such data can also be information about the system configuration in case the devices need to be aware of each other. For example, if one device (e.g., a remotely accessible observation camera) is identified by its phone number, and is replaced (e.g., due to stealing or breaking down) with a similar device with a new phone number, this change in the system must take place in every device that needs to connect to the replaced device. Yet another example of such data type is the personal settings in devices. For instance, if a user has selected a ringing tone to a mobile phone, he or she may desire to have all his phones ring with the same melody.

Typically, synchronizing this data requires actions from the user, who must initiates the synchronization session. The session can also be initiated automatically after every change in the system, either by a server-side push, or as an automatic action in the terminal after every change made by the user.

However, even with good synchronization techniques the management of a system consisting of all the communications devices a user owns, becomes problematic. If there are several synchronization servers a device needs to connect to (e.g., one for each type of data to be synchronized: a calendar server, a contacts server, a photograph server, a music server), the definitions for these connections are needed in the mobile terminal. And if anything changes, the change must also be reflected to the terminal.

Another problem occurs when there is more and more data to be synchronized, and the different terminals offer different support for various data types. For instance, a calendar synchronization server does not have to support every calendar data type in the devices that synchronize their calendars to that server.

A problem specific to mobile communications devices is the identification and authorization of the user to the network. In the GSM standard, this problem is addressed using a SIM card. However, switching the SIM card from device to device is tedious. There are several proposed solutions for the problem, for instance by introducing multiple SIM cards with the same identity or by incorporating a virtual SIM card located outside the GSM phone.

Another issue complicating multiple device ownership is the adaptation of services to different types of devices differing in capabilities such as display resolution, amount of memory available, and different support for various existing file formats.

Thus, there is a need to establish a virtual counterpart of each physical device of a user and manage the physical devices using these virtual counterparts. Further, there is a need to carry out device-to-device synchronizations within a virtual device domain as a network service. Yet further, there is a need for a system and method for device group management using a virtual device domain.

### SUMMARY OF THE INVENTION

The present invention is directed to a method, system, computer program product, and business method where virtual counterparts of a user's multiple physical devices facilitate the management and synchronization of these physical devices. For example, switching on a new physical device causes the synchronized, up-to-date data to be downloaded from its virtual counterpart.

Briefly, one exemplary embodiment relates to a method for managing devices using a virtual device domain. The method includes establishing a virtual device for each physical device of one or more devices associated with a user and synchronizing the virtual device with one or more other virtual devices.

Another exemplary embodiment relates to a computer program product for synchronizing virtual devices in a virtual device domain. The computer program product includes computer code to establish a virtual device in the virtual device domain for each physical device of one or more devices associated with a user and synchronize the virtual device with one or more other virtual devices in the virtual device domain.

Yet another exemplary embodiment relates to a system for managing devices using a virtual domain. The system includes a number of physical devices associated with a user and a virtual device domain including virtual devices for each of the number of physical devices. The virtual devices include device capability information for corresponding physical devices, and the number of physical devices are synchronized by the corresponding virtual devices once the virtual devices synchronize.

Another exemplary embodiment relates to a business method for providing a virtual device domain including virtual devices corresponding to physical devices associated with a user. The business method includes associating a communication service with a plurality of physical devices and managing the plurality of physical devices using virtual devices in a virtual device domain. Managing the plurality of physical devices includes synchronizing the virtual devices.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a diagrammatic representation of a system having multiple communication devices.

FIG. 2 is a diagrammatic representation of a virtual device domain system including virtual counterparts of physical communication devices in accordance with an exemplary embodiment.

FIG. 3 is a diagrammatic representation depicting device addition operations in the virtual device domain system of FIG. 2 in accordance with an exemplary embodiment.

FIG. 4 is a diagrammatic representation depicting device synchronization operations in the virtual device domain system of FIG. 2 in accordance with an exemplary embodiment.

FIG. 5 is a diagrammatic representation depicting device removal operations in the virtual device domain system of FIG. 2 in accordance with an exemplary embodiment.

FIG. 6 is a diagrammatic representation depicting a device disabling operation using a menu-based presentation in the virtual device domain system of FIG. 2 in accordance with an exemplary embodiment.

FIG. 7 is a diagrammatic representation of a data processing device in accordance with an exemplary embodiment.

### DETAILED DESCRIPTION OF EXEMPLARY EMBODIMENTS

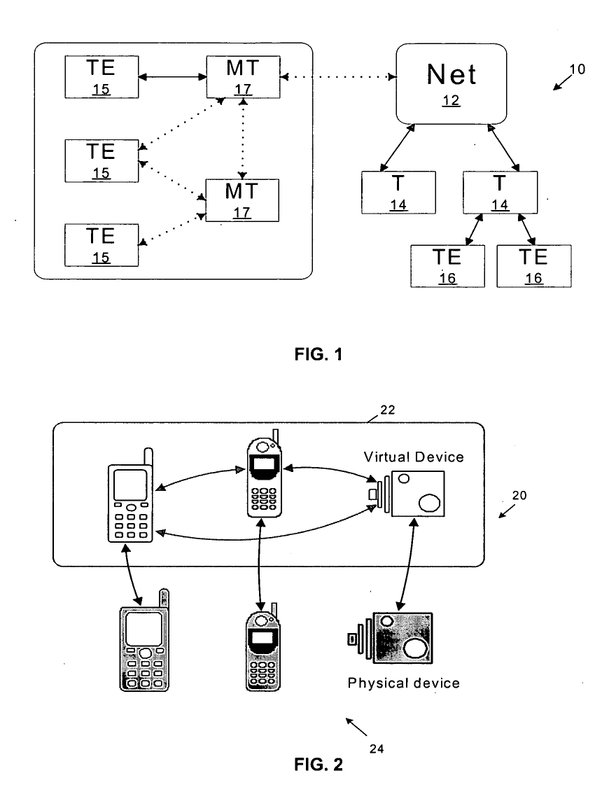

FIG. 1 illustrates a system 10 of many communication-enabled devices. A person may own more than one mobile phone, accessories such as headsets, PDAs and remote equipment, such as burglar alarm systems and observation cameras. On the left in FIG. 1 are local devices a user owns. For example, local devices can include terminal equipment (TE) 15 and mobile terminals (MT) 17. One of the physical mobile phones owned can form a User Equipment (UE), consisting of a Terminal Equipment (TE) that provides e.g. the user interface, a Mobile Terminal (MT) that provides radio access, and a USIM (Universal Subscriber Identity Module) providing identification to the network. Terminal Equipment can also be replaceable and used with several Mobile Terminals. One example of such piece of equipment is a headset.

The user may also own devices or systems to be used remotely over a network 12. Such systems can have access to the network 12 via a fixed or mobile terminal 14. They can also have additional parts of their own, which can also be considered pieces of Terminal Equipment (TE 16) in the same way as in the mobile case.

Changing and configuring equipment is common. For instance, a user can switch a headset from one phone to another, or he can switch phones according to the needs in his varying usage contexts. He can also buy new devices, possibly replacing some existing ones. In some cases some equipment can also be removed from a system. Especially in case where one device is lost or stolen, the risk of losing important data, or providing an intruder an access to the system is imminent.

FIG. 2 illustrates a system 20 including a virtual device domain or virtual counterparts 22 of physical communication devices 24. The system 20 automatically maintains a copy of the data of every device of the user in the network. Synchronizations and backups can be performed against the virtual device, transparently to the user. Furthermore, a visual presentation of the virtual counterparts 22 in the user's domain provides an efficient and easily understandable way for the user to manage, configure and control the devices.

Every physical communication device of the real world has a virtual counterpart or a Virtual Device. Every physical device in this embodiment has a connection to its Virtual Device. This connection may be implemented, e.g. using SyncML technology. The network data is kept in synchronization with the data in the physical device and vice versa via this connection. All the Virtual Devices have been connected together, but a virtual device may exist also without connection to the other virtual device(s). All Virtual Devices and their connections together comprise the Virtual Device Domain 22. The Virtual Device Domain 22 can be presented to the end user by a Virtual Device Domain user interface using an Internet Connection, for example.

The implementation of Virtual Device Domain can be varied. In an exemplary embodiment, the Virtual Device Domain 22 is located on a network server maintained by a cellular network operator, or another service provider. The means to control the properties of the Virtual Device Domain 22 are settings for the connections inside Virtual Device Domain 22 and for the connections between Virtual Devices and the physical devices. The Virtual Device Domain 22 can also be located in user personal computer or any other suitable device.

The everyday administering change scenarios of using multiple devices, such as adding, removing and replacing as well as activating and deactivating them are accomplished using the Virtual Device Domain 22. For example, when purchasing a new device and activating it into use, the initial setup of a device happens. The initial set up requires the user, or a representative of the service operator, to add a virtual counterpart of the device into the Virtual Device Domain 22, and make the necessary settings for linking it into the physical device. After the addition, the system configuration and service settings used in the other devices can be delivered to the virtual device, and further to the physical device. This need not happen at the sales point but the user can, for instance, make a phone call to the service provider, informing of the type of device user has purchased. The service provider can then setup the device capability profile in the Virtual Device Domain 22, for example, with the help of a description file offered by the device manufacturer. Also the selection of which data the device is interested in may be made at this phase. Preferably, the user will not have to care about most of the data types. For instance, the system configuration and typical applications such as calendar and phonebook can be automatically included in the set of synchronized data.

Synchronizations that otherwise would otherwise occur between physical devices, or between a device and various databases, takes place between the virtual device (or device proxy) and the other entities such as a server or proxies of other devices. The only synchronization connection required by the mobile terminal is that between the physical device and its own virtual device. This simplifies the terminal design: all configurations between device and several other entities to be synchronized with, can be hidden from the physical device. The physical device only needs to know how to synchronize data with its proxy. Connections to other entities can be defined in the device proxy. Any changes to the configuration can be handled in the virtual device, they need not happen in the physical terminal. Yet, this does not prevent devices to exchange data locally, without involving the proxy, e.g. when there is no network connection.

In an example implementation, a provider of a service that, for example, offers distribution or synchronization of music, needs not know about all the different music data formats its clients may use. The service provider may offer support for one format only, and the implementer of the device proxy (e.g., the manufacturer of the physical device) can implement transcoding from that format to one supported by the physical device. Also, the possible differences in implementing various data formats (such as varying support for data fields in VCal-formatted calendar data entries) can be handled in the virtual device. The virtual device can have more capabilities than the physical device, so it is more capable of solving possible problems related to data formats. The filtering, rendering, or transcoding of the downloaded data according to the device capabilities may be done in the network in advance to when it is needed, to conserve time when switching devices.

The synchronization between the virtual device and the physical device can be implemented using a data sharing technology, such as SyncML, or even FTP. Also, synchronizations between the virtual device and other entities can use SyncML. The virtual device can be a complete object, sharing an exact copy of the data in the physical device. It can also be just a front end (providing, for example, transcoding services) towards various databases. However, in an alternative embodiment, the virtual device is a complete object, having its own, possibly format-converted copies of data existing in the larger synchronization servers.

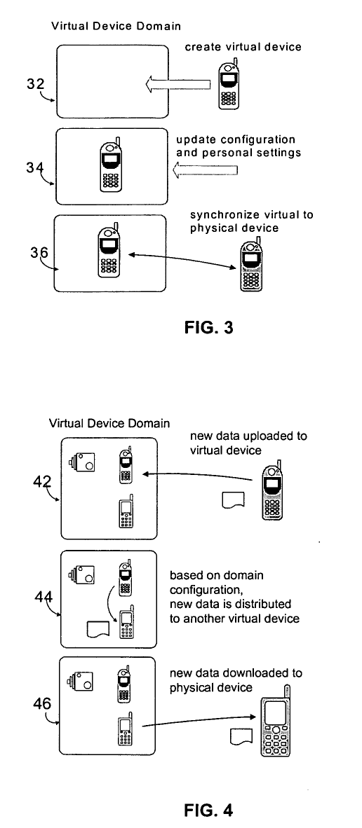

FIG. 3 illustrates addition operations in the system 20 of FIG. 2. Additional, fewer, or different operations may be performed, depending on the embodiment. In activation of either a newly acquired device, or a previously used one, all the relevant data is automatically downloaded from the Virtual Device Domain. This can be done in the background, transparently to the user while using the device.

In an operation 32, a virtual device is created corresponding to a new physical device. The physical device can be a cell phone, a personal digital assistant (PDA), a laptop computer, or any other of a variety of devices. In an operation 34, configuration and personal settings are updated at the Virtual Device Domain. Such configuration and personal settings include information regarding the new physical device, including its capabilities. In an operation 36, the virtual device is synchronized to the physical device.

FIG. 4 illustrates synchronization operations in the system 20 of FIG. 2. Additional, fewer, or different operations may be performed, depending on the embodiment. If the device has previously been used for creating data that is to be synchronized to other devices, but e.g. no network coverage has been available at that time, the activation of the device may require also synchronization activities, instead of a simple download. Another action that may need to take place is transcoding the data. For instance, the device may be incapable of displaying high-resolution pictures due to its memory and display limitations. In that case, it may be beneficial to downgrade the local copies of the pictures during the download.

In an operation 42, new data on the physical device is uploaded to its corresponding virtual device in the Virtual Device Domain. The new data could be a phone number, an appointment, or any other data obtained by the physical device. In an operation 44, the new data in distributed to other virtual devices based on the domain configuration. For instance, the domain can be configured to distribute calendar appointments only to devices having a calendar function. In an operation 46, the new data is downloaded from the virtual devices receiving the new data to corresponding physical devices.

By way of example, after up-to-date data is in the user's phone, the user can, for instance, take a picture using a camera in the device. Assuming that the photo album is among the data that is selected to be synchronized, the picture taken is automatically uploaded to the Virtual Device Domain and synchronized to the other active devices that are set up to receive photo album data. As for the inactive devices, this synchronization occurs the next time they are turned on. This synchronization is done in the background, without user activity related, e.g. to initiating the transfer or dealing with authorization issues.

An instance of user generating data without realizing it occurs when the user is changing the system configuration. For instance, the user can change the number of her voice mailbox or other settings. These settings must also be synchronized to other devices. With the Virtual Device Domain that happens automatically, without the user having to realize that synchronization is needed.

There may also be changes that require synchronization, stemming from activities of others than the user herself. For instance, service configuration can happen due to actions of the network operator. Settings for some operator service may normally be stored in the phones of the customers. With the Virtual Device Domain, this information can be updated to the configuration database in the Virtual Device Domain, being instantly available for all the active devices after the automatic synchronization has taken place.

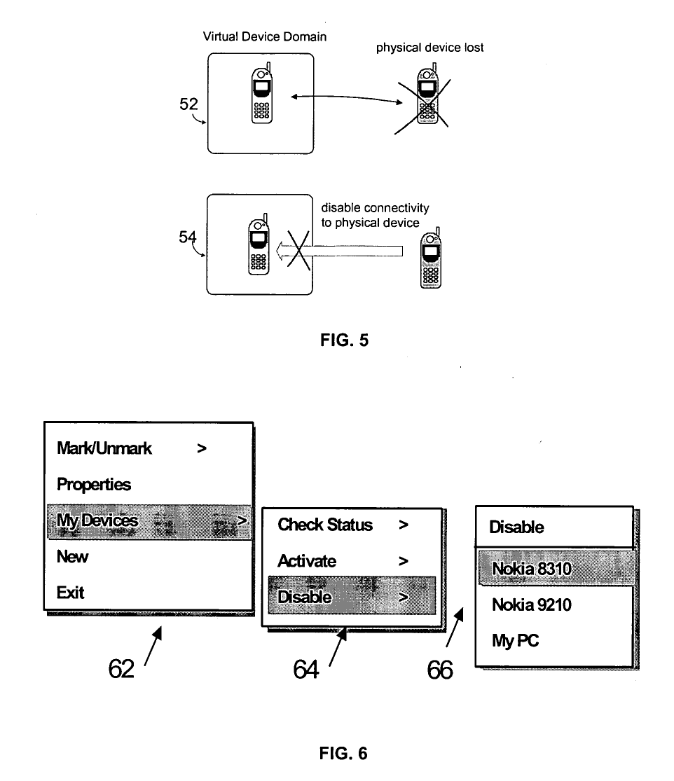

FIG. 5 illustrates removal operations in the system 20 of FIG. 2. Additional, fewer, or different operations may be performed, depending on the embodiment. In deactivating a device, no further actions than informing the system that the device is becoming inactive, are needed. In the case of accidental loss of a device, the virtual counterpart of the device should not be removed immediately, but all credentials the physical device has for accessing the network and its services must be disabled. As such, the network backup of the user's essential data, including device-specific settings, can be restored to a new physical device.

In an operation 52, a physical device is lost, but the virtual device counterpart is maintained. In an operation 54, connectivity to a physical device can be disabled. When for example, selling the device with no intention of replacing it with a new one, the removal of the virtual device from the Virtual Device Domain is performed by deleting its virtual representation and all references to it in the system configuration.

Replacement differs from a simple addition in that a new physical device is added, linking it into an already existing virtual counterpart. No new virtual device is created at that phase. A backup exists in the Virtual Device Domain and essential data can be recovered if a device is lost or stolen.

The Virtual Device Domain includes domain management, synchronization and user interface solutions. Domain management consists of domain creation, device and configuration management. A user interface can be used for device management, as most of the functionality of Virtual Device Domain is transparent to the user. Authorization mechanisms, clearly needed for secure synchronization and domain management, can be included in the user interface to the Virtual Device Domain.

In the creation of a new Virtual Device Domain, a definition of the group of the user's devices is created. Such definition helps determine ways to manage applications, services and data on user's devices, e.g. to add/remove a device to the group and distribution/disabling an application on (some of) the devices in the group. For example, authorization and synchronization relationships can be created and managed for devices and applications in the manner shown in Table 1. The symbol “+” in Table 1 indicates that relationship exists. The data in each category is synchronized between selected devices. However, for backup purposes, all or part of the data in each device is backed up in its own virtual device.

TABLE 1

Devices belonging to the user

| Data Category | Dev1 | Dev2 | Dev3 | PC |
|---|---|---|---|---|
| Calendar | + | + | + | + |
| Pictures | + | − | − | + |
| Games | + | − | − | − |
| Music | − | − | + | + |
| Money | + | + | − | − |
| System | + | + | + | + |
| Configuration | | | | |

When adding a new device, a data entity for the virtual device is created to the Virtual Device Domain. Also, the link between the data entity and its physical counterpart is established. In the data entity, a device capability profile is needed, for instance, to enable later rendering and transcoding of data. This profile can be offered by the device manufacturer or it can be defined by the user, operator, or some other party. For configuration management, a protocol for device configuration can be defined in SyncML, which is capable of providing system and service configurations to devices over the air. Also, other suitable protocols can be used.

The synchronizations needed are between Virtual Devices and each physical device and its counterpart in the Virtual Device Domain. In principle, synchronizations between physical devices are unnecessary, but also allowed. SyncML is one of the technologies that can be used for implementing all the synchronization functionalities.

Advantageously, the Virtual Device Domain solves the problem of synchronizing active and inactive devices. Many mobile phones can't be used for anything (except for emergency calls) without a SIM, so device-to-device synchronization is impossible if the user has a single SIM. With Virtual Devices Domain, the active device is kept synchronized with its Virtual Device, that in turn is synchronized with the virtual counterparts of each inactive device. The physical devices are synchronized on activation.

FIG. 6 illustrates a device disabling operation using a menu-based presentation. The menu-based presentation includes menus 62,64, and 66. The user interface presented in a mobile terminal for the Virtual Device Domain can be minimal, as all synchronizations including authorization mechanisms are made transparent to the user. However, the concept of having virtual copies of every physical device is presented, regardless of the underlying techniques for implementing the Virtual Device Domain. FIG. 6 illustrates an example of a user preventing a device from accessing the Virtual Device Domain.

If it is not practical to backup all data in a physical device, for instance, due to too heavy synchronization data traffic for functional implementation, the user must be aware of what data is not backed up. This must be made explicit in the user interface. Further, the definition of authorization and synchronization relations is presented in the user interface. In practice, a set of default relations can exist. For instance, the system configuration can always be synchronized between devices.

When switching devices, a user often has little patience or time to perform device-to-device synchronizations or reconfiguration. The consequence can be a discontinuity in information and service availability. Furthermore, neglecting synchronization when switching devices may result in a later laborious synchronization procedure involving every device. Multiple device ownership cannot be supported satisfactorily by user device level solutions only. The virtual device domain concept described with reference to FIGS. 1-6 provides a solution where automatic synchronization done between virtual devices allows the information to flow to a newly activated device even after the switch in a manner that is transparent to the user.

In case of device loss, the Virtual Device Domain provides a means for ensuring that at least part of the lost information can be restored from the virtual device domain. The user interface for the Virtual Device Domain can offer a visible presentation of the existence and availability of a backup in such a situation for the user. It also offers a straightforward way of protecting system security by disabling the connection between the physical and virtual devices.

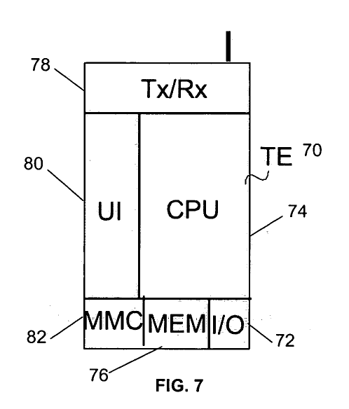

FIG. 7 illustrates a simplified structure of a data processing device (TE) 70 according to an exemplary embodiment. The data processing device (TE) 70 can be, for example, a mobile terminal, a PDA device or a personal computer (PC). The data processing device (TE) 70 comprises an I/O means (I/O) 72, a central processing unit (CPU) 74, and a memory (MEM) 76. The information used to communicate with different external parties, e.g. a CD-ROM, other devices and the user, is transmitted through the I/O means (I/O) 72 to/from the central processing unit (CPU) 74. If the data processing device (TE) 70 is implemented as a mobile station, it typically includes a transceiver Tx/Rx 78, which communicates with a wireless network, typically with a base transceiver station (BTS) through an antenna. User Interface (UI) 80 equipment typically includes a display, a keypad, a microphone and a loudspeaker. The data processing device (TE) 70 may further comprise a connecting means (MMC) 82, such as a standard form slot, for various hardware modules, which may provide various applications to be run in the data processing device (TE) 70.

This detailed description outlines exemplary embodiments of a method, device, system, and a computer program product for device group management using a virtual device domain. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

1. A method for managing devices using a virtual device domain, the method comprising:
establishing a virtual device for each physical device of one or more devices associated with a user; and
synchronizing the virtual device with one or more other virtual devices.

2. The method claim 1, further comprising synchronizing the virtual device with external databases.

3. The method of claim 1, wherein establishing a virtual device for each physical device comprises creating the virtual device in a virtual device domain and updating settings in the virtual device.

4. The method of claim 3, wherein the settings comprise configuration and personal settings, synchronizing the virtual device with one or more other virtual devices, is based on a domain configuration.

5. The method of claim 1, wherein synchronizing the virtual device with one or more other virtual devices is based on a domain configuration.

6. A computer program product that manages devices using a virtual device domain, the computer program product comprising:
computer code to:
establish a virtual device within a virtual device domain for each physical device associated with a user; and
synchronize the virtual device with one or more virtual devices in the virtual device domain.

7. The computer program product of claim 6, further comprising a user interface to facilitate administration of the virtual devices.

8. The computer program product of claim 6, wherein the computer code includes code to administer configuration and personal settings, and the virtual device is synchronized with one or more other virtual devices, based on a domain configuration.

9. A system for managing devices using a virtual domain, the system comprising:
a number of physical devices associated with a user; and
a virtual device domain including virtual devices for each of the number of physical devices, wherein the virtual devices include device capability information for corresponding physical devices, and wherein the number of physical devices are synchronized by the corresponding virtual devices.

10. The system of claim 9, wherein synchronization of the virtual devices is based on a domain configuration.

11. The system of claim 9, wherein the virtual device is located in the network.

12. The system of claim 9, wherein the virtual device domain is in a personal computer.

13. The system of claim 9, wherein the virtual devices can be administered by the user over a network.

14. The system of claim 13, wherein the network is the Internet.

15. The system of claim 9, wherein the physical devices communicate data to the virtual devices to provide a backup of the data.

16. The system of claim 9, wherein the Virtual Device Domain resides in a server associated with a communication provider.

17. The system of claim 9, wherein the Virtual Device Domain comprises domain configuration including transcoding rules.

18. The system of claim 9, wherein the synchronization follows a SyncML specification.

19. The system of claim 9, wherein the virtual devices have relationships between each other defined by a configuration and used in administering and managing the Virtual Device Domain, wherein the administering and managing is done using an application that provides a visual presentation of the virtual devices and the relationships.

20. A business method for providing a virtual device domain including virtual devices corresponding to physical devices associated with a user, the business method comprising:
associating a communication service with a plurality of physical devices; and
managing the plurality of physical devices using virtual devices in a virtual device domain, wherein managing the plurality of physical devices includes synchronizing the virtual devices.

21. The business method of claim 20, wherein managing the plurality of physical devices comprises tracking services and configurations of the virtual devices in the virtual device domain for billing purposes.

22. The business method of claim 20, further comprising synchronizing the virtual devices according to a payment plan configuration.
